(19) United States
(12) Patent Application Publication
(10) Pub. No.: US 2026/0245812 A1
(43) Pub. Date: Aug. 20, 2026

(54) KEY STRUCTURE

(71) Applicant: CHICONY ELECTRONICS CO., LTD., New Taipei City (TW)

(72) Inventors: Chun-Ting LIN, New Taipei City (TW); Bo-Wei SU, New Taipei City (TW)

(21) Appl. No.: 19/217,096

(22) Filed: May 23, 2025

(30) Foreign Application Priority Data
Feb. 18, 2025 (TW) 114105949

(51) Int. Cl. H01H 13/20

(52) U.S. Cl. CPC H01H 13/20

(57) ABSTRACT

A key structure includes a keycap, a base plate, and a connecting assembly. The connecting assembly includes a first connecting member, a second connecting member, and an elastic member. The first connecting member includes a limiting frame, a first side, and a second side. The limiting frame is positioned on the first side. The first side is connected to the keycap, while the second side is connected to the base plate. The second connecting member is pivotally connected to the first connecting member. The two opposite sides of the second connecting member are respectively connected to the keycap and the base plate. The elastic member includes a fixed end and a first elastic arm. The fixed end is secured to the first connecting member. One end of the first elastic arm is connected to the fixed end, while the other end passes through the limiting frame.

### CROSS-REFERENCE TO RELATED APPLICATION

This application claims the priority benefit of Taiwan application serial No. 114105949, filed on Feb. 18, 2025. The entirety of the above-mentioned patent application is hereby incorporated by reference herein and made a part of this specification.

### BACKGROUND

### 1. Technical Field

The present disclosure relates to a key structure.

### 2. Description of the Related Art

At present, in terms of common computer usage habits, the keyboard is one of the indispensable input devices. Both computers and keyboards are being developed toward designs that are lighter, thinner, shorter, and more compact. To achieve a thinner profile, membrane circuit boards are typically used, and an input signal is generated by an elastic member of the key structure triggering a membrane circuit switch. In contrast, mechanical keyboards generate input signals through contact and conduction between metallic components within the key structure. As a result, the key structure of a membrane keyboard cannot reproduce the metallic clicking sound and feel of mechanical key structures.

However, although many users prefer the clicking sound and tactile feedback of the key structure of mechanical keyboards, they still find the appearance of mechanical keyboards to be bulky. Accordingly, designers and manufacturers of membrane keyboards are in urgent need of developing a membrane keyboard, or a key structure thereof, that can produce a clicking sound similar to that of a mechanical keyboard.

### SUMMARY

In view of the issue above, it is a primary object of the present disclosure to provide a key structure that, through a novel configuration of its connecting assembly and elastic member, addresses the problem wherein prior art membrane keyboards are unable to produce a clicking sound similar to that of mechanical key structures.

To achieve the above objective, the present disclosure provides a key structure, which comprises a keycap, a base plate and a connecting assembly. The connecting assembly comprises a first connecting member, a second connecting member and an elastic member. The first connecting member comprises a limiting frame, a first side and a second side opposite to each other. The limiting frame is disposed on the first side. The first side is connected to the keycap, and the second side is connected to the base plate. The second connecting member is pivotally connected to the first connecting member. Two opposite sides of the second connecting member are respectively connected to the keycap and the base plate. The elastic member comprises a fixed end and a first elastic arm. The fixed end is secured to the first connecting member. One end of the first elastic arm is connected to the fixed end, and the other end passes through the limiting frame.

According to an embodiment of the present disclosure, the other end of the first elastic arm, after passing through the limiting frame, is located above the second connecting member or the base plate.

According to an embodiment of the present disclosure, the limiting frame comprises a top side and a bottom side. When the keycap is pressed, the first elastic arm is interfered with by the second connecting member or the base plate such that the first elastic arm abuts against the top side of the limiting frame. When the second connecting member does not interfere with the first elastic arm, the first elastic arm rebounds and contacts the bottom side of the limiting frame.

According to an embodiment of the present disclosure, the bottom side of the limiting frame is made of a metallic material.

According to an embodiment of the present disclosure, the limiting frame comprises a top side, a bottom side, and a guiding portion. The guiding portion is located between the bottom side and the top side, and a width of the guiding portion increases in a direction from the bottom side toward the top side.

According to an embodiment of the present disclosure, the base plate further comprises an interference structure protruding toward the keycap. The other end of the first elastic arm passes through the limiting frame and is located above the interference structure.

According to an embodiment of the present disclosure, the first connecting member further comprises a fixing shaft, one side of the fixing shaft is connected to a sidewall of the first connecting member. The fixed end of the elastic member is sleeved onto the fixing shaft.

According to an embodiment of the present disclosure, the fixing shaft comprises a limiting portion. The limiting portion is located on a side of the fixing shaft away from the sidewall of the first connecting member. The fixed end of the elastic member is disposed between the sidewall of the first connecting member and the limiting portion.

According to an embodiment of the present disclosure, the elastic member further comprises a second elastic arm. One end of the second elastic arm is connected to the fixed end, such that the elastic member forms a torsion spring structure.

According to an embodiment of the present disclosure, the second elastic arm is positioned closer to the sidewall of the first connecting member than the first elastic arm.

According to an embodiment of the present disclosure, the first connecting member further comprises a fixing portion connected to a sidewall of the first connecting member. The elastic member is a spring plate, and the fixed end of the elastic member is connected to the fixing portion.

According to an embodiment of the present disclosure, the first connecting member is an outer frame, and the second connecting member is an inner frame. The limiting frame and the elastic member are disposed on a sidewall of the first connecting member facing the second connecting member.

According to an embodiment of the present disclosure, the first connecting member is an inner frame, and the second connecting member is an outer frame. The limiting frame and the elastic member are disposed on a sidewall of the first connecting member facing the second connecting member.

According to an embodiment of the present disclosure, when the keycap is pressed, the first side of the first connecting member slides relative to the keycap.

According to an embodiment of the present disclosure, the elastic member is made of a metal material.

In continuation of the above, according to the key structure of the present disclosure, the key structure comprises a keycap, a base plate, and a connecting assembly. The connecting assembly comprises a first connecting member and a second connecting member that are pivotally connected to each other, as well as an elastic member. The first connecting member, which is connected to one side of the keycap, is provided with a limiting frame and the elastic member. The elastic member comprises a fixed end and a first elastic arm. The fixed end is secured to the first connecting member. One end of the first elastic arm is connected to the fixed end, and the other end passes through the limiting frame. Accordingly, when the keycap is pressed, the distal end of the first elastic arm that passed through the limiting frame moves downward until it is interfered with by part of the key structure (e.g., the second connecting member or the base plate), causing the first elastic arm to be pushed (interfered with) against the top side of the limiting frame. When the second connecting member no longer interferes with the first elastic arm, the first elastic arm rebounds and contacts the limiting frame, thereby generating a sound produced by the first elastic arm striking the limiting frame. As a result, a clicking sound simulating that of a mechanical key structure can be achieved.

### BRIEF DESCRIPTION OF THE DRAWINGS

FIG. 1 is a schematic view of a key structure according to a first embodiment of the present disclosure;

FIG. 2A is a schematic view of the key structure shown in FIG. 1 with the keycap removed;

FIG. 2B is a partially enlarged view of the key structure shown in FIG. 2A;

FIG. 3A is a sectional view of the key structure taken along line A-A of FIG. 2A;

FIG. 3B is a sectional view of the key structure shown in FIG. 3A in a pressed state;

FIG. 4 is a schematic force-displacement curve of the key structure shown in FIG. 1 when pressed;

FIG. 5 is a schematic view of a key structure according to a second embodiment of the present disclosure with the keycap removed;

FIG. 6 is a sectional view of the key structure taken along line B-B of FIG. 5;

FIG. 7 is a schematic view of a key structure according to a third embodiment of the present disclosure with the keycap removed;

FIG. 8A is a sectional view of the key structure taken along line C-C of FIG. 7;

FIG. 8B is a sectional view of the key structure shown in FIG. 8A in a pressed state;

FIG. 9 is a schematic view of a key structure according to a fourth embodiment of the present disclosure with the keycap removed; and

FIG. 10 is a side view of the key structure shown in FIG. 9.

### DETAILED DESCRIPTION OF THE EMBODIMENTS

In order to make the structure, characteristics, and effectiveness of the disclosure further understood and recognized, a detailed description of the disclosure is provided as follows, along with embodiments and accompanying figures.

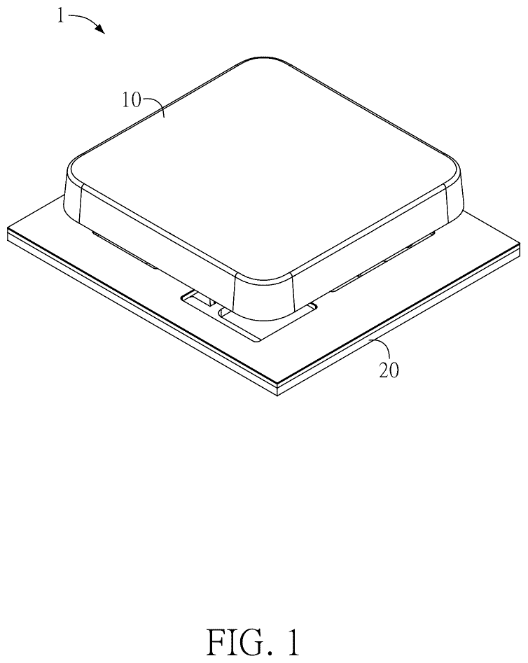

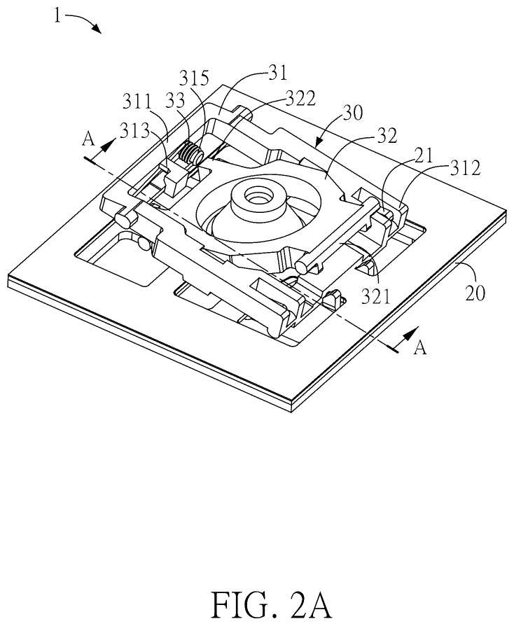

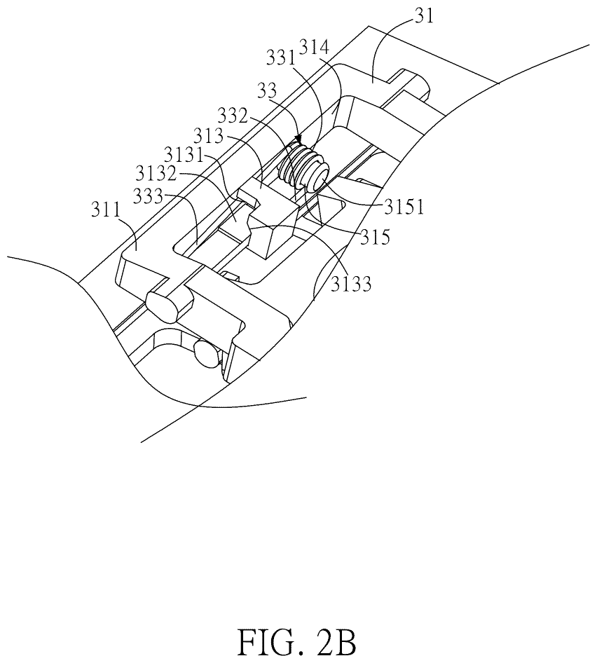

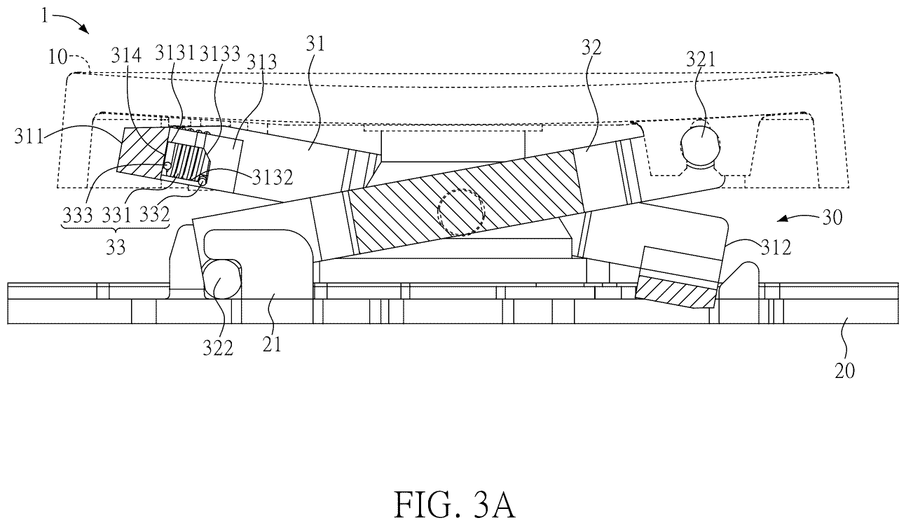

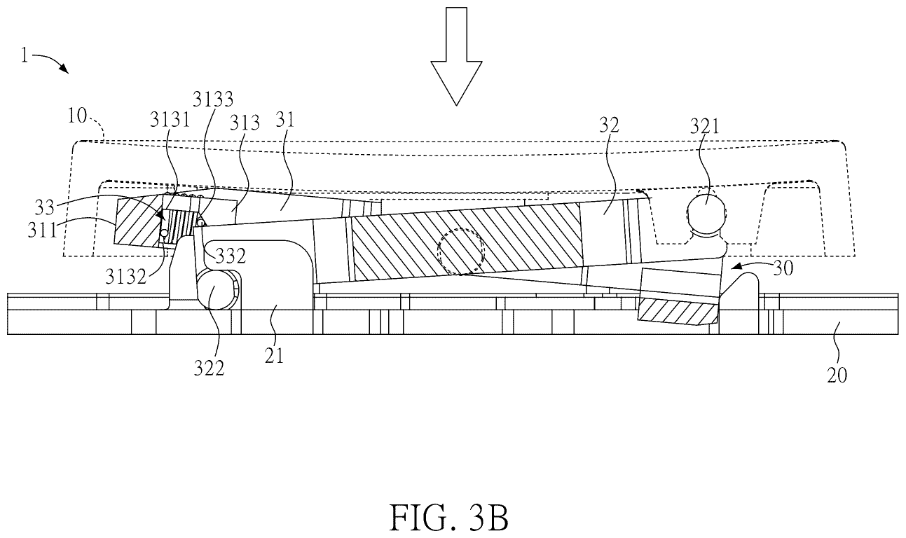

FIG. 1 is a schematic view of a key structure according to a first embodiment of the present disclosure; FIG. 2A is a schematic view of the key structure shown in FIG. 1 with the keycap removed; FIG. 2B is a partially enlarged view of the key structure shown in FIG. 2A; FIG. 3A is a sectional view taken along line A-A of the key structure shown in FIG. 2A; and FIG. 3B is a sectional view of the key structure shown in FIG. 3A in a pressed state. Please refer to FIG. 1, FIG. 2A, FIG. 2B, FIG. 3A, and FIG. 3B. The key structure 1 of this embodiment comprises a keycap 10, a base plate 20, and a connecting assembly 30. It should be noted that in the drawings, the base plate 20 is illustrated corresponding to a single key structure 1. In actual applications, a plurality of key structures 1 may correspond to a single base plate 20. The connecting assembly 30 comprises a first connecting member 31, a second connecting member 32, and an elastic member 33. The second connecting member 32 is pivotally connected to the first connecting member 31. The first connecting member 31 includes a first side 311 and a second side 312 opposite to each other, and a limiting frame 313. The first side 311 is connected to the keycap 10, and the second side 312 is connected to the base plate 20. The limiting frame 313 is disposed on the first side 311, which is connected to the keycap 10. Preferably, the limiting frame 313 is a rectangular frame structure and comprises a top side 3131 and a bottom side 3132 opposite to each other, as shown in FIG. 2B.

In this embodiment, the first side 311 of the first connecting member 31, which is connected to the keycap 10, functions as a sliding side, while the second side 312 of the first connecting member 31, which is connected to the base plate 20, functions as a fixed side. The second connecting member 32 also comprises a third side 321 and a fourth side 322 opposite to each other, which are connected to the keycap 10 and the base plate 20, respectively. The base plate 20 includes a plurality of hooks 21. The second side 312 of the first connecting member 31 and the fourth side 322 of the second connecting member 32 are respectively connected to the hooks 21 of the base plate 20. Furthermore, the third side 321 of the second connecting member 32, which is connected to the keycap 10, is a fixed side, while the fourth side 322, which is connected to the base plate 20, is a sliding side. When the keycap 10 is pressed, the first side 311 of the first connecting member 31 slides relative to the keycap 10, and the fourth side 322 of the second connecting member 32 slides relative to the base plate 20, thereby enabling the keycap 10 to move up and down relative to the base plate 20. In other embodiments, the first side 311 and the fourth side 322 may alternatively serve as fixed sides. The present disclosure is not limited thereto.

As shown in FIG. 2B and FIG. 3A, the elastic member 33 of this embodiment comprises a fixed end 331 and a first elastic arm 332. The fixed end 331 is secured to the first connecting member 31, for example, to a side wall 314 of the first connecting member 31. Preferably, both the limiting frame 313 and the elastic member 33 are disposed on the side wall 314 of the first connecting member 31 that faces the second connecting member 32. In this embodiment, the first connecting member 31 serves as an outer frame, while the second connecting member 32 serves as an inner frame. Accordingly, the limiting frame 313 and the elastic member 33 are disposed on the inner side wall of the outer frame. In other embodiments, the limiting frame 313 and the elastic member 33 may alternatively be disposed on the side wall of the first connecting member 31 that faces away from the second connecting member 32 (e.g., the outer side wall of the outer frame). The present disclosure is not limited thereto.

Further, one end of the first elastic arm 332 is connected to the fixed end 331, and the other end passes through the limiting frame 313. Preferably, as shown in FIG. 2A and FIG. 2B, the first connecting member 31 further comprises a fixed shaft 315, one side of which is connected to the side wall 314 of the first connecting member 31. The fixed end 331 of the elastic member 33 is sleeved around the fixed shaft 315. Preferably, the fixed shaft 315 further comprises a limiting portion 3151, as shown in FIG. 2B. The limiting portion 3151 is located on the side of the fixed shaft 315 that is away from the side wall 314 of the first connecting member 31, such that the fixed end 331 of the elastic member 33 is positioned between the side wall 314 and the limiting portion 3151. In other words, the fixed end 331 is confined between the side wall 314 and the limiting portion 3151 to prevent the fixed end 331 from detaching from the fixed shaft 315.

The other end of the first elastic arm 332, hereinafter referred to as the distal end, is a free end. The distal end of the first elastic arm 332 passes through the limiting frame 313. Preferably, after passing through the limiting frame 313, the distal end of the first elastic arm 332 is positioned above the second connecting member 32 or the base plate 20. In this embodiment, the distal end of the first elastic arm 332 is positioned above the second connecting member 32 after passing through the limiting frame 313, as shown in FIG. 3A and FIG. 3B. When the keycap 10 is pressed, the first side 311 of the first connecting member 31 and the third side 321 of the second connecting member 32 move downward. At this time, the limiting frame 313 and the elastic member 33 also move downward along with the first connecting member 31. The distal end of the first elastic arm 332 moves downward until it is interfered with by the second connecting member 32. The second connecting member 32 pushes (interferes with) the first elastic arm 332 toward the top side 3131 of the limiting frame 313, causing it to press against the top side and accumulate elastic force. When the second connecting member 32 no longer interferes with the first elastic arm 332, the first elastic arm 332 releases the stored elastic force, rebounds, and strikes the bottom side 3132 of the limiting frame 313, thereby generating an impact sound from the first elastic arm 332 striking the limiting frame 313. This simulates the clicking sound of a mechanical key structure. Preferably, the bottom side 3132 of the limiting frame 313 may be made of a metallic material to ensure that the impact sound generated by the first elastic arm 332 remains consistent over repeated use, thereby enhancing the durability of the limiting frame 313. In this embodiment, the entire connecting assembly 30 may be made of a plastic material. For example, a metal sheet may be disposed on the bottom side 3132 of the limiting frame 313 to form a metallic bottom side 3132. Alternatively, the bottom side 3132 may be formed of a metallic material by dual-shot molding, while other portions of the limiting frame 313 remain made of a plastic material. The present disclosure is not limited thereto. In other embodiments, the distal end of the first elastic arm 332 may correspond to other interfering structures of the key structure 1 after passing through the limiting frame 313. When the keycap 10 is pressed, the distal end of the first elastic arm 332 may be pushed by the interfering structure to achieve the same clicking sound effect.

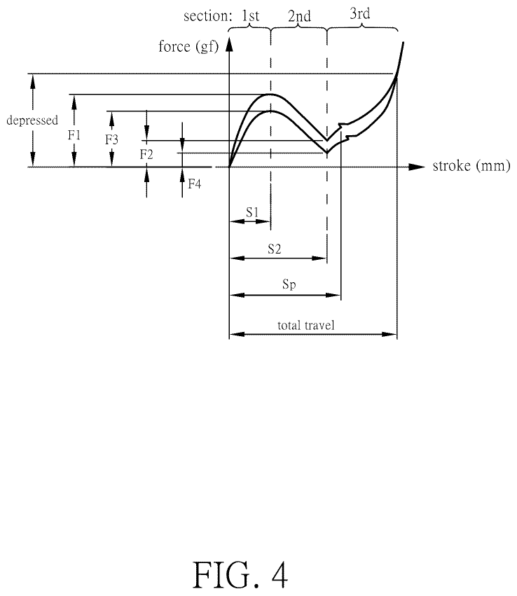

FIG. 4 is a force-displacement curve diagram of the key structure shown in FIG. 1 when pressed. Please refer to FIG. 4. The two curves in FIG. 4 represent two repeated press tests. The horizontal axis indicates the stroke in millimeters (mm) of the key structure 1, and three stroke positions are marked: S1, S2, and Sp. The vertical axis indicates the applied force in gram-force (gf). The corresponding pressing forces at stroke position S1 are F1 and F3, while the corresponding pressing forces at stroke position S2 are F2 and F4. In this embodiment, the key structure 1 is designed such that the first elastic arm 332 rebounds and contacts the limiting frame 313 to generate a clicking sound in the second section. From the curve in FIG. 4, it can be observed that the second section represents the stroke in which the restoring elastic member of the key structure 1, such as a rubber dome as shown in FIG. 2A, collapses under downward force. At this point, the second connecting member 32 no longer interferes with the first elastic arm 332, allowing the arm to rebound and strike the limiting frame 313 to produce the clicking sound. In other embodiments, the key structure 1 may also be configured to generate the clicking sound in the first or third section. The present disclosure is not limited thereto.

Preferably, the limiting frame 313 of this embodiment further comprises a guiding portion 3133. The guiding portion 3133 is located between the bottom side 3132 and the top side 3131, and is positioned at the end of the limiting frame 313 away from the side wall 314. The first elastic arm 332 is located within a space formed by the side wall 314 of the first connecting member 31, the top side 3131, the bottom side 3132, and the guiding portion 3133 of the limiting frame 313. Preferably, the first elastic arm 332 is in contact with the guiding portion 3133. Furthermore, the width of the guiding portion 3133 increases gradually from the bottom side 3132 toward the top side 3131. In other words, the guiding portion 3133 becomes thicker closer to the top side 3131. Therefore, when the keycap 10 is pressed and the distal end of the first elastic arm 332 is interfered with by the second connecting member 32, the guiding portion 3133 guides the first elastic arm 332 to move in the direction toward the top side 3131 and outward relative to the second connecting member 32, as shown in FIG. 3B. The distal end of the first elastic arm 332 is guided to a position where it no longer interferes with the second connecting member 32. As such, the timing of the first elastic arm 332 disengaging from interference and generating the clicking sound can be controlled by adjusting the structure of the guiding portion 3133.

Preferably, the elastic member 33 of the present embodiment further comprises a second elastic arm 333. One end of the second elastic arm 333 is connected to the fixed end 331, such that the elastic member 33 forms a torsion spring structure. Preferably, the other end (i.e., the free end) of the second elastic arm 333 may pass through the limiting frame 313. In other embodiments, the other end of the second elastic arm 333 may be positioned within the limiting frame 313 or may not enter the limiting frame 313. The present disclosure is not limited thereto. Moreover, the second elastic arm 333 is positioned closer to the side wall 314 of the first connecting member 31 than the first elastic arm 332. Specifically, in this embodiment, the elastic member 33 is a torsional coil spring made of metal. The fixed end 331 is the coiled portion of the spring and is sleeved onto the fixed shaft 315. In this embodiment, the second elastic arm 333 is arranged closer to the side wall 314 of the first connecting member 31, while the first elastic arm 332 is positioned closer to the guiding portion 3133, so as to prevent the first elastic arm 332 from being interfered with by the side wall 314 and ensure proper operation within the limiting frame 313. Furthermore, the structure of the second elastic arm 333 can enhance the rebound force of the first elastic arm 332, thereby producing the clicking sound.

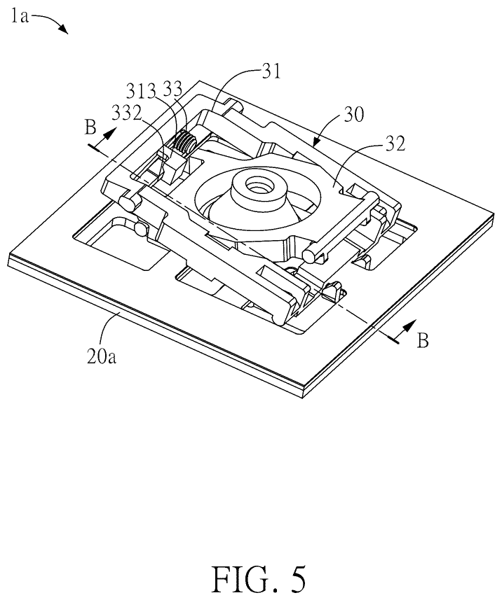

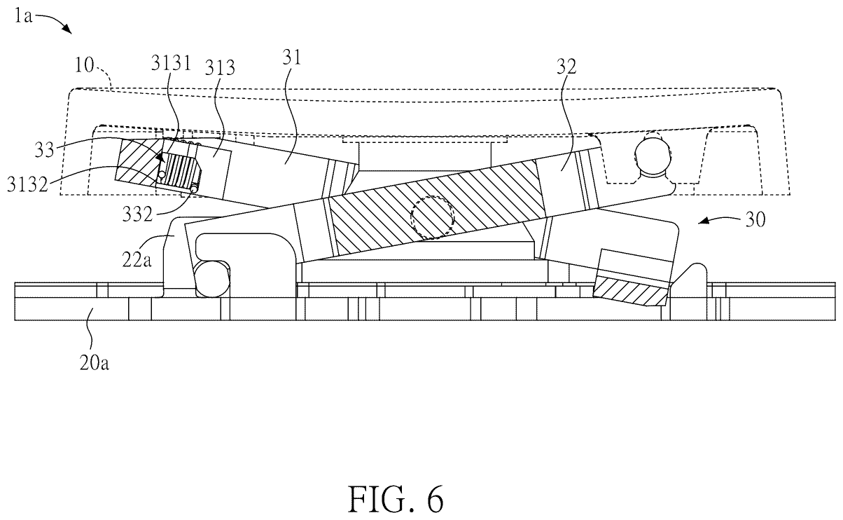

FIG. 5 is a schematic diagram of the key structure of a second embodiment of the present disclosure with the keycap removed; and FIG. 6 is a sectional view of the key structure along line B-B of FIG. 5. Please refer to FIG. 5 and FIG. 6. The key structure 1a of this embodiment also comprises a keycap 10 (represented by dashed lines in FIG. 6), a base plate 20a, and a connecting assembly 30. The structure of the keycap 10 and the connecting assembly 30 is similar to that of the previous embodiment, accordingly, reference may be made to the foregoing description. The difference between the key structure 1a of this embodiment and that of the first embodiment lies in that the base plate 20a of the present embodiment further comprises an interfering structure 22a, which protrudes upward from the base plate 20a (i.e., in the direction of the keycap 10). The interfering structure 22a may be an upright plate structure formed on the base plate 20a through a stamping process. However, the present disclosure is not limited to this configuration. The interfering structure 22a corresponds to the distal end (i.e., the free end) of the first elastic arm 332. Accordingly, in this embodiment, the distal end of the first elastic arm 332 is positioned above the interfering structure 22a after passing through the limiting frame 313.

When the keycap 10 is pressed, the limiting frame 313 and the elastic member 33 also move downward together with the first connecting member 31. The distal end of the first elastic arm 332 moves downward until it is interfered with by the interfering structure 22a of the base plate 20a. The interfering structure 22a pushes (interferes with) the first elastic arm 332 toward the top side 3131 of the limiting frame 313, causing the first elastic arm 332 to be pushed and store elastic energy. When the interfering structure 22a no longer interferes with the first elastic arm 332, the first elastic arm 332 releases the stored energy and thus rebounds to contact the bottom side 3132 of the limiting frame 313. This action simultaneously generates an impact sound as the first elastic arm 332 strikes the limiting frame 313, thereby achieving the effect of simulating the clicking sound of a mechanical key structure.

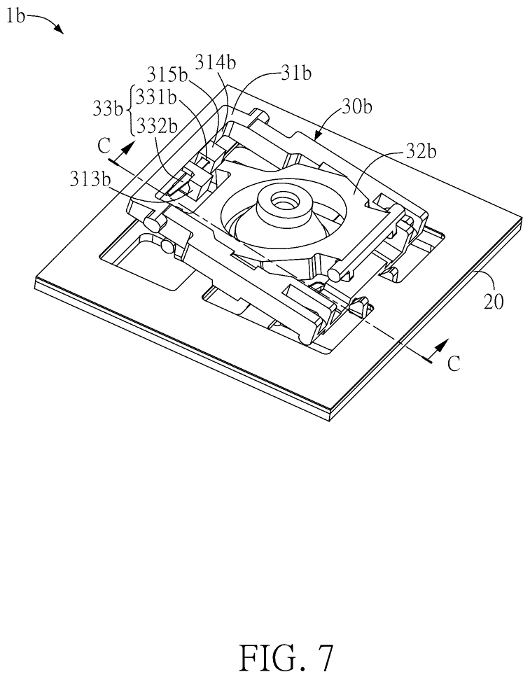

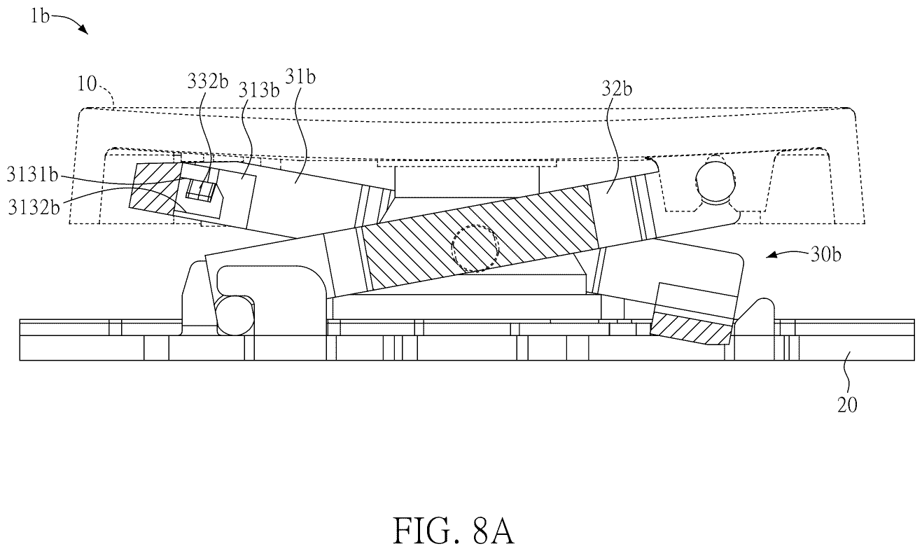

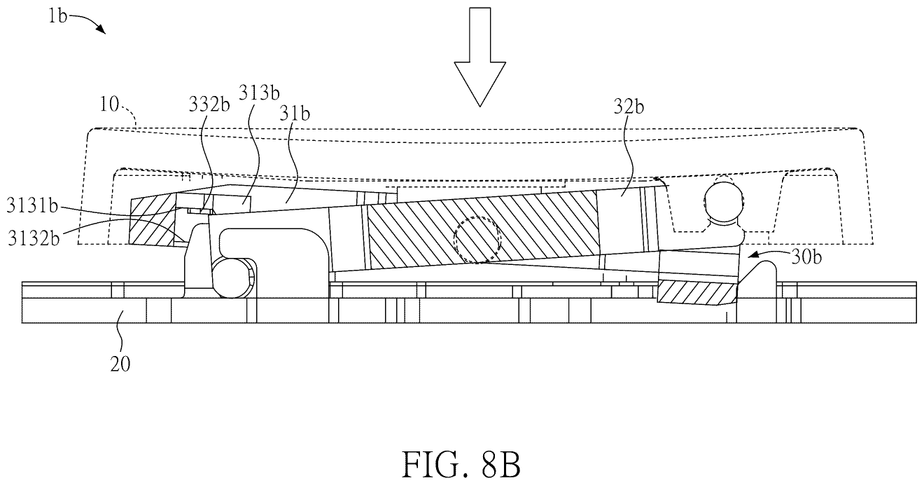

FIG. 7 is a schematic diagram of the key structure of a third embodiment of the present disclosure with the keycap removed; FIG. 8A is a sectional view of the key structure along line C-C of FIG. 7; and FIG. 8B is a sectional view showing the key structure under pressing. Please refer to FIG. 7, FIG. 8A, and FIG. 8B. The key structure 1b of this embodiment also comprises a keycap 10 (shown in dashed lines in FIGS. 8A and 8B), a base plate 20, and a connecting assembly 30b. The structures of the keycap 10 and the base plate 20 are similar to that of the previous embodiments, accordingly, reference may be made to the foregoing description. The difference between the key structure 1b of the present embodiment and the first embodiment lies in that the elastic member 33b of this embodiment is a metal elastic plate. The elastic member 33b similarly comprises a fixed end 331b and a first elastic arm 332b. The fixed end 331b is fixed to the first connecting member 31b.

As shown in FIG. 7, preferably, the first connecting member 31b of the present embodiment further comprises a fixing portion 315b. Similarly, the fixing portion 315b is connected to a sidewall 314b of the first connecting member 31b (i.e., the inner sidewall of the outer frame) and is disposed adjacent to the limiting frame 313b. The fixed end 331b of the elastic member 33b is connected to the fixing portion 315b. It should be noted that the fixed end 331b of the present embodiment is inserted into the fixing portion 315b; therefore, in FIG. 7, the fixed end 331b is indicated at the outer edge of the fixing portion 315b. One end of the first elastic arm 332b is connected to the fixed end 331b, while the other end is at least partially located inside the limiting frame 313b. In this embodiment, the distal end of the first elastic arm 332b also passes through the limiting frame 313b and corresponds to the second connecting member 32b.

When the keycap 10 is pressed, the limiting frame 313b and the elastic member 33b also move downward together with the first connecting member 31b. The distal end of the first elastic arm 332b moves downward until it is interfered with by the second connecting member 32b. The second connecting member 32b pushes (interferes with) the first elastic arm 332b toward the top side 3131b of the limiting frame 313b, causing the arm to be pushed and store elastic energy, as shown in FIG. 8B. When the second connecting member 32b no longer interferes with the first elastic arm 332b, the first elastic arm 332b similarly releases the stored energy, rebounds, and contacts the bottom side 3132b of the limiting frame 313b. This action simultaneously generates an impact sound as the first elastic arm 332b strikes the limiting frame 313b, thereby achieving the effect of simulating the clicking sound of a mechanical key structure.

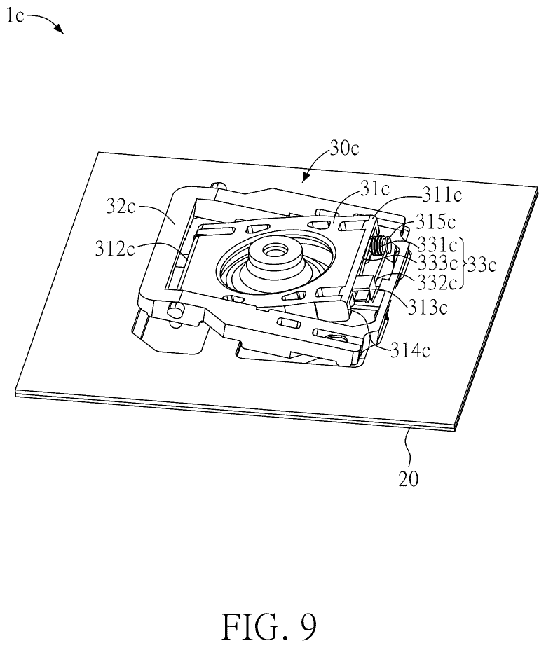

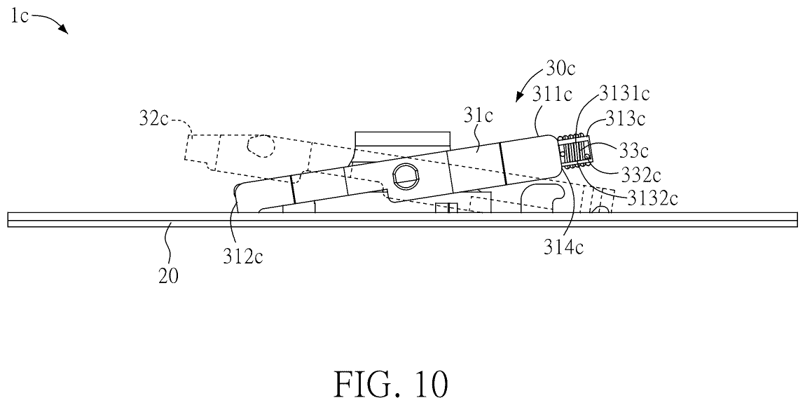

FIG. 9 is a schematic diagram showing a key structure according to a fourth embodiment of the present disclosure with the keycap removed; and FIG. 10 is a side view of the key structure shown in FIG. 9. Please refer to FIG. 9 and FIG. 10. The key structure 1c of this embodiment also comprises a keycap 10 (refer to FIG. 1), a base plate 20, and a connecting assembly 30c. The structure of the keycap 10 and the base plate 20 is similar to that of the previous embodiments, reference may be made to the foregoing description accordingly; the description of the keycap 10 may be referred to in FIG. 1. The difference between the key structure 1c of the present embodiment and that of the first embodiment lies in that the first connecting member 31c of the connecting assembly 30c is an inner frame, and the second connecting member 32c is an outer frame. The first connecting member 31c also comprises an opposing first side 311c and second side 312c, and a limiting frame 313c. Similarly, the first side 311c is connected to the keycap 10, and the second side 312c is connected to the base plate 20. The limiting frame 313c is disposed on the first side 311c. In the present embodiment, the first side 311c refers to the fixed side of the first connecting member 31c (i.e., inner frame) connected to the keycap 10, and the second side 312c refers to the sliding side. That is, when the keycap 10 is pressed, the first side 311c of the first connecting member 31c remains stationary relative to the keycap 10, while the second side 312c moves along the base plate 20.

Preferably, in this embodiment, the limiting frame 313c and the elastic member 33c are disposed on a sidewall 314c of the first connecting member 31c (i.e., the inner frame) facing the second connecting member 32c. In other words, the limiting frame 313c and the elastic member 33c are located on the outer sidewall of the inner frame (i.e., the first connecting member 31c). As shown in FIG. 9, the elastic member 33c of this embodiment also adopts a torsion spring structure and comprises a fixed end 331c, a first elastic arm 332c, and a second elastic arm 333c. The fixed end 331c is fixed to the first connecting member 31c. The first connecting member 31c of this embodiment further comprises a fixing shaft 315c, which is also located on the sidewall 314c. The fixed end 331c of the elastic member 33c is sleeved onto the fixing shaft 315c, thereby securing it to the sidewall 314c of the first connecting member 31c. One end of each of the first elastic arm 332c and the second elastic arm 333c is connected to the fixed end 331c.

The other end (i.e., the distal end) of the first elastic arm 332c passes through the limiting frame 313c, while the other end of the second elastic arm 333c may be located either inside or outside the limiting frame 313c; the present disclosure is not limited thereto. When the keycap 10 is pressed, the limiting frame 313c and the elastic member 33c also move downward along with the first side 311c of the first connecting member 31c. The distal end of the first elastic arm 332c moves downward until it is interfered with by the second connecting member 32c (i.e., the outer frame). The second connecting member 32c pushes the first elastic arm 332c toward the top side 3131c of the limiting frame 313c, thereby storing elastic force. In other embodiments, when the distal end of the first elastic arm 332c moves downward, it may also be interfered with by the base plate 20 or other structures of the key structure 1c; the present disclosure is not limited thereto. When the second connecting member 32c no longer interferes with the first elastic arm 332c, the first elastic arm 332c rebounds and contacts the bottom side 3132c of the limiting frame 313c, thereby generating a sound of impact as the first elastic arm 332c strikes the limiting frame 313c. As a result, the effect of simulating the clicking sound of a mechanical key structure can be achieved.

In continuation of the above, according to the key structure of the present disclosure, the key structure comprises a keycap, a base plate, and a connecting assembly. The connecting assembly comprises a first connecting member and a second connecting member that are pivotally connected to each other, as well as an elastic member. The first connecting member, which is connected to one side of the keycap, is provided with a limiting frame and the elastic member. The elastic member comprises a fixed end and a first elastic arm. The fixed end is secured to the first connecting member. One end of the first elastic arm is connected to the fixed end, and the other end passes through the limiting frame. Accordingly, when the keycap is pressed, the distal end of the first elastic arm that passed through the limiting frame moves downward until it is interfered with by part of the key structure (e.g., the second connecting member or the base plate), causing the first elastic arm to be pushed (interfered with) against the top side of the limiting frame. When the second connecting member no longer interferes with the first elastic arm, the first elastic arm rebounds and contacts the limiting frame, thereby generating a sound produced by the first elastic arm striking the limiting frame. As a result, a clicking sound simulating that of a mechanical key structure can be achieved.

Although the present disclosure has been explained in relation to its preferred embodiments, it is to be understood that many other possible modifications and variations can be made without departing from the spirit and scope of the disclosure as hereinafter claimed.

What is claimed is:

1. A key structure, comprising:
a keycap;
a base plate; and
a connecting assembly, comprising:
a first connecting member, comprising a limiting frame, a first side and a second side opposite to each other, the limiting frame being disposed on the first side, the first side being connected to the keycap, and the second side being connected to the base plate;
a second connecting member pivotally connected to the first connecting member, two opposite sides of the second connecting member being respectively connected to the keycap and the base plate; and
an elastic member, comprising a fixed end and a first elastic arm, the fixed end being secured to the first connecting member, one end of the first elastic arm being connected to the fixed end, the other end passing through the limiting frame.

2. The key structure according to claim 1, wherein the other end of the first elastic arm, after passing through the limiting frame, is located above the second connecting member or the base plate.

3. The key structure according to claim 2, wherein the limiting frame comprises a top side and a bottom side, and when the keycap is pressed, the first elastic arm is interfered with by the second connecting member or the base plate such that the first elastic arm abuts against the top side of the limiting frame; and when the second connecting member does not interfere with the first elastic arm, the first elastic arm rebounds and contacts the bottom side of the limiting frame.

4. The key structure according to claim 3, wherein the bottom side of the limiting frame is made of a metallic material.

5. The key structure according to claim 2, wherein the limiting frame comprises a top side, a bottom side, and a guiding portion located between the bottom side and the top side, and a width of the guiding portion increases in a direction from the bottom side toward the top side.

6. The key structure according to claim 1, wherein the base plate further comprises an interference structure protruding toward the keycap, and the other end of the first elastic arm passes through the limiting frame and is located above the interference structure.

7. The key structure according to claim 1, wherein the first connecting member further comprises a fixing shaft, one side of the fixing shaft being connected to a sidewall of the first connecting member, and the fixed end of the elastic member is sleeved onto the fixing shaft.

8. The key structure according to claim 7, wherein the fixing shaft comprises a limiting portion located on a side of the fixing shaft away from the sidewall of the first connecting member, and the fixed end of the elastic member is disposed between the sidewall of the first connecting member and the limiting portion.

9. The key structure according to claim 7, wherein the elastic member further comprises a second elastic arm, one end of the second elastic arm being connected to the fixed end, such that the elastic member forms a torsion spring structure.

10. The key structure according to claim 9, wherein the second elastic arm is positioned closer to the sidewall of the first connecting member than the first elastic arm.

11. The key structure according to claim 1, wherein the first connecting member further comprises a fixing portion connected to a sidewall of the first connecting member, the elastic member is a spring plate, and the fixed end of the elastic member is connected to the fixing portion.

12. The key structure according to claim 1, wherein the first connecting member is an outer frame, the second connecting member is an inner frame, and the limiting frame and the elastic member are disposed on a sidewall of the first connecting member facing the second connecting member.

13. The key structure according to claim 1, wherein the first connecting member is an inner frame, the second connecting member is an outer frame, and the limiting frame and the elastic member are disposed on a sidewall of the first connecting member facing the second connecting member.

14. The key structure according to claim 1, wherein when the keycap is pressed, the first side of the first connecting member slides relative to the keycap.

15. The key structure according to claim 1, wherein the elastic member is made of a metal material.
